(19) United States
(12) Patent Application Publication
(10) Pub. No.: US 2010/0284466 A1
(43) Pub. Date: Nov. 11, 2010

(54) VIDEO AND DEPTH CODING

(75) Inventors: Purvin Bibhas Pandit, Franklin Park, NJ (US); Peng Yin, Plainsboro, NJ (US); Dong Tian, Plainsboro, NJ (US)

Correspondence Address: Robert D. Shedd, Patent Operations;THOMSON Licensing LLC, P.O. Box 5312, Princeton, NJ, 08543-5312, US

(73) Assignee: THOMSON LICENSING, Boulogne-Billancourt (FR)

(21) Appl. No.: 12/735,393

(22) PCT Filed: Dec. 18, 2008
(86) PCT No.: PCT/US08/13822

§ 371 Date: Jul. 9, 2010

Related U.S. Application Data
(60) Provisional application No. 61/010,823, filed on Jan. 11, 2008.

(51) Int. Cl. H04N 7/26

(52) U.S. Cl. 375/240.16; 375/E07.123

(57) ABSTRACT

Various implementations are described. Several implementations relate to video and depth coding. One method includes selecting a component of video information for a picture. A motion vector is determined for the selected video information or for depth information for the picture. The selected video information is coded based on the determined motion vector. The depth information is coded based on the determined motion vector. An indicator is generated that the selected video information and the depth information are coded based on the determined motion vector. One or more data structures are generated that collectively include the coded video information, the coded depth information, and the generated indicator.

### CROSS-REFERENCE TO RELATED APPLICATIONS

This application claims the benefit of U.S. Provisional Application Ser. No. 61/010,823, filed on Jan. 11, 2008, titled “Video and Depth Coding”, the contents of which are hereby incorporated by reference in their entirety for all purposes.

### TECHNICAL FIELD

Implementations are described that relate to coding systems. Various particular implementations relate to video and depth coding.

### BACKGROUND

It has been widely recognized that multi-view video coding (MVC) is a key technology that serves a wide variety of applications including, for example, free-viewpoint and three dimensional (3D) video applications, home entertainment, and surveillance. Depth data may be associated with each view. Depth data is useful for view synthesis, which is the creation of additional views. In multi-view applications, the amount of video and depth data involved can be enormous. Thus, there exists the need for a framework that helps improve the coding efficiency of current video coding solutions that, for example, use depth data or perform simulcast of independent views.

### SUMMARY

According to a general aspect, a component of video information for a picture is selected. A motion vector is determined for the selected video information or for depth information for the picture. The selected video information is coded based on the determined motion vector. The depth information is coded based on the determined motion vector. An indicator is generated that the selected video information and the depth information are each coded based on the determined motion vector. One or more data structures are generated that collectively include the coded video information, the coded depth information, and the generated indicator.

According to another general aspect, a signal is formatted to include a data structure. The data structure includes coded video information for a picture, coded depth information for the picture, and an indicator. The indicator indicates that the coded video information and the coded depth information are coded based on a motion vector determined for the video information or for the depth information.

According to another general aspect, data is received that includes coded video information for a video component of a picture, coded depth information for the picture, and an indicator that the coded video information and the coded depth information are coded based on a motion vector determined for the video information or for the depth information. The motion vector is generated for use in decoding both the coded video information and the coded depth information. The coded video information is decoded based on the generated motion vector, to produce decoded video information for the picture. The coded depth information is decoded based on the generated motion vector, to produce decoded depth information for the picture.

The details of one or more implementations are set forth in the accompanying drawings and the description below. Even if described in one particular manner, it should be clear that implementations may be configured or embodied in various manners. For example, an implementation may be performed as a method, or embodied as apparatus, such as, for example, an apparatus configured to perform a set of operations or an apparatus storing instructions for performing a set of operations, or embodied in a signal. Other aspects and features will become apparent from the following detailed description considered in conjunction with the accompanying drawings and the claims.

### BRIEF DESCRIPTION OF THE DRAWINGS

FIG. 1 is a diagram of an implementation of a coding structure for a multi-view video coding system with eight views.

FIG. 2 is a diagram of an implementation of a coding structure for a multi-view video plus depth coding system with 3 views.

FIG. 3 is a block diagram of an implementation of a prediction of depth data of view i.

FIG. 4 is a block diagram of an implementation of an encoder for encoding multi-view video content and depth.

FIG. 5 is a block diagram of an implementation of a decoder for decoding multi-view video content and depth.

FIG. 6 is a block diagram of an implementation of a video transmitter.

FIG. 7 is a block diagram of an implementation of a video receiver.

FIG. 8 is a diagram of an implementation of an ordering of view and depth data.

FIG. 9 is a diagram of another implementation of an ordering of view and depth data.

FIG. 10 is a flow diagram of an implementation of an encoding process.

FIG. 11 is a flow diagram of another implementation of an encoding process.

FIG. 12 is a flow diagram of yet another implementation of an encoding process.

FIG. 13 is a flow diagram of an implementation of a decoding process.

FIG. 14 is a flow diagram of another implementation of an encoding process.

FIG. 15 is a block diagram of another implementation of an encoder.

FIG. 16 is a flow diagram of another implementation of a decoding process.

FIG. 17 is a block diagram of another implementation of a decoder.

### DETAILED DESCRIPTION

In at least one implementation, we propose a framework to code multi-view video plus depth data. In addition, we propose several ways in which coding efficiency can be improved to code the video and depth data. Moreover, we describe approaches in which the depth signal can use not only another depth signal but also the video signal to improve the coding efficiency.

One of many problems addressed is the efficient coding of multi-view video sequences. A multi-view video sequence is a set of two or more video sequences that capture the same scene from different view points. While depth data may be associated with each view of multi-view content, the amount of video and depth data in some multi-view video coding applications may be enormous. Thus, there exists the need for a framework that helps improve the coding efficiency of current video coding solutions that, for example, use depth data or perform simulcast of independent views.

Since a multi-view video source includes multiple views of the same scene, there typically exists a high degree of correlation between the multiple view images. Therefore, view redundancy can be exploited in addition to temporal redundancy and is achieved by performing view prediction across the different views.

In one practical scenario, multi-view video systems involving a large number of cameras will be built using heterogeneous cameras, or cameras that have not been perfectly calibrated. With so many cameras, the memory requirement of the decoder can increase to large amounts and can also increase the complexity. In addition, certain applications may only require decoding some of the views from a set of views. As a result, it might not be necessary to completely reconstruct the views that are not needed for output.

Additionally some views may only carry depth information and are then subsequently synthesized at the decoder using the associated depth data. Depth data can also be used to generate intermediate virtual views.

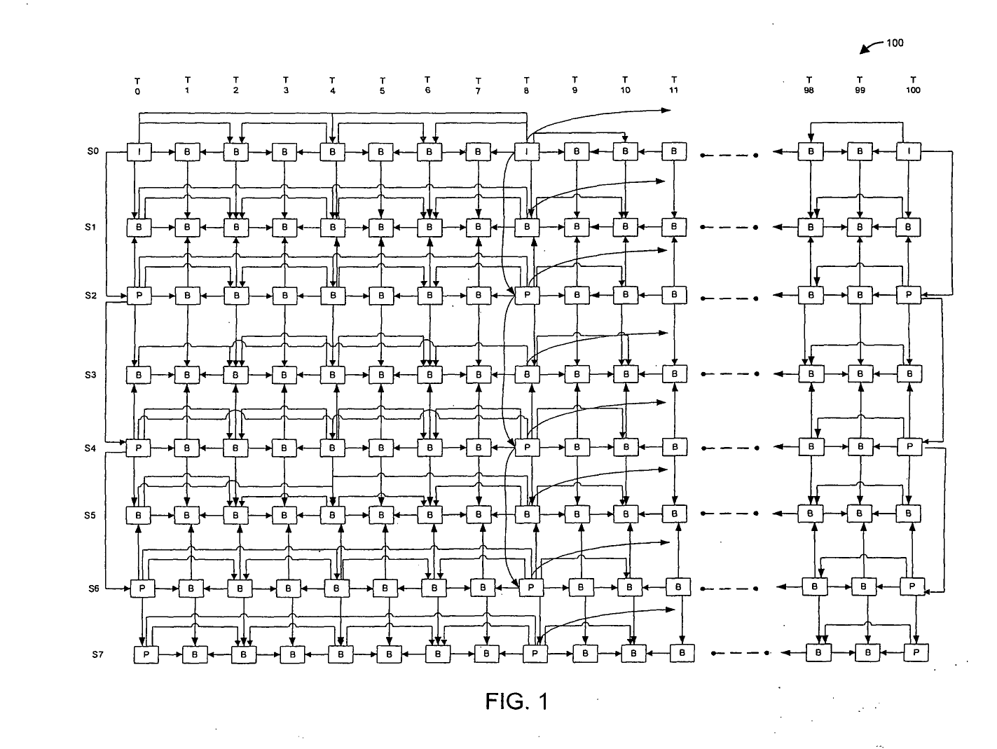

The current multi-view video coding extension of H.264/AVC (hereinafter also “MVC Specification”) specifies a frame work for coding video data only. The MVC Specification makes use of the temporal and inter-view dependencies to improve the coding efficiency. An exemplary coding structure 100, supported by the MVC Specification, for a multi-view video coding system with 8 views, is shown in FIG. 1. The arrows in FIG. 1 show the dependency structure, with the arrows pointing from a reference picture to a picture that is coded based on the reference picture. At a high level, syntax is signaled to indicate the prediction structure between the different views. This syntax is shown in TABLE 1. In particular, TABLE 1 shows the sequence parameter set directed to the MVC Specification, in accordance with an implementation.

TABLE 1

| | | |
|---|---|---|
| seq_parameter_set_mvc_extension( ) { | C | Descriptor |

| | |
|---|---|
| num_views_minus_1 | ue(v) |
| for(i = 0; i <= num_views_minus_1; i++) | |

| | |
|---|---|
| view_id[i] | ue(v) |

for(i = 0; i <= num_views_minus_1; i++) {

| | |
|---|---|
| num_anchor_refs_I0[i] | ue(v) |
| for( j = 0; j < num_anchor_refs_I0[i]; j++ ) | |

| | |
|---|---|
| anchor_ref_I0[i][j] | ue(v) |

| | |
|---|---|
| num_anchor_refs_I1[i] | ue(v) |
| for( j = 0; j < num_anchor_refs_I1[i]; j++ ) | |

| | |
|---|---|
| anchor_ref_I1[i][j] | ue(v) |

}
for(i = 0; i <= num_views_minus_1; i++) {

| | |
|---|---|
| num_non_anchor_refs_I0[i] | ue(v) |
| for( j = 0; j < num_non_anchor_refs_I0[i]; j++ ) | |

| | |
|---|---|
| non_anchor_ref_I0[i][j] | ue(v) |

| | |
|---|---|
| num_non_anchor_refs_I1[i] | ue(v) |
| for( j = 0; j < num_non_anchor_refs_I1[i]; j++ ) | |

| | |
|---|---|
| non_anchor_ref_I1[i][j] | ue(v) |

}

}

In order to improve the coding efficiency further, several tools such as illumination compensation and motion skip mode have been proposed. The motion skip tool is briefly described below.

### Motion Skip Mode for Multi-View Video Coding

Motion skip mode is proposed to improve the coding efficiency for multi-view video coding. Motion skip mode is based at least on the concept that there is a similarity of motion between two neighboring views.

Motion skip mode infers the motion information, such as macroblock type, motion vector, and reference indices, directly from the corresponding macroblock in the neighboring view at the same temporal instant. The method may be decomposed into two stages, for example, the search for the corresponding macroblock in the first stage and the derivation of motion information in the second stage. In the first stage of this example, a global disparity vector (GDV) is used to indicate the corresponding position in the picture of the neighboring view. The method locates the corresponding macroblock in the neighboring view by means of the global disparity vector. The global disparity vector is measured in macroblock-sized units between the current picture and the picture of the neighboring view, so that the GDV is a coarse vector indicating position in macroblock-sized units. The global disparity vector can be estimated and decoded periodically, for example, every anchor picture. In that case, the global disparity vector of a non-anchor picture may be interpolated using the recent global disparity vectors from the anchor picture. For example, GDV of a current picture, c, is GDVc=w1*GDV1+w2*GDV2, where w1 and w2 are weighting factors based on the inverse of distance between the current picture and, respectively, anchor picture 1 and anchor picture 2. In the second stage, motion information is derived from the corresponding macroblock in the picture of the neighboring view, and the motion information is copied to apply to the current macroblock.

Motion skip mode is preferably disabled for the case when the current macroblock is located in the picture of the base view or in an anchor picture as defined in the joint multi-view video model (JMVM). This is because the picture from the neighbor view is used to present another method for the inter prediction process. That is, with motion skip mode, the intention is to borrow coding mode/inter prediction information from the reference view. But the base view does not have a reference view, and anchor pictures are Intra coded so no inter prediction is done. Thus, it is preferable to disable MSM for these cases.

Note that in JMVM the GDVs are transmitted.

To notify a decoder of the use of motion skip mode, a new flag, motion_skip_flag, is included in, for example, the header of the macroblock layer syntax for multi-view video coding. If motion_skip_flag is turned on, the current macroblock derives the macroblock type, motion vector, and reference indices from the corresponding macroblock in the neighboring view.

Coding Depth Data Separately from Video Data

The current multi-view video coding specification under work by the Joint Video Team (JVT) specifies a framework for coding video data only. As a result, applications that require generating intermediate views (such as, for example, free viewpoint TV (FTV), immersive media, and 3D teleconferencing) using depth are not fully supported. In this framework, reconstructed views can then be used as inter-view references in addition to the temporal prediction for a view. FIG. 1 shows an exemplary coding structure 100 for a multi-view video coding system with eight views, to which the present principles may be applied, in accordance with an implementation of the present principles.

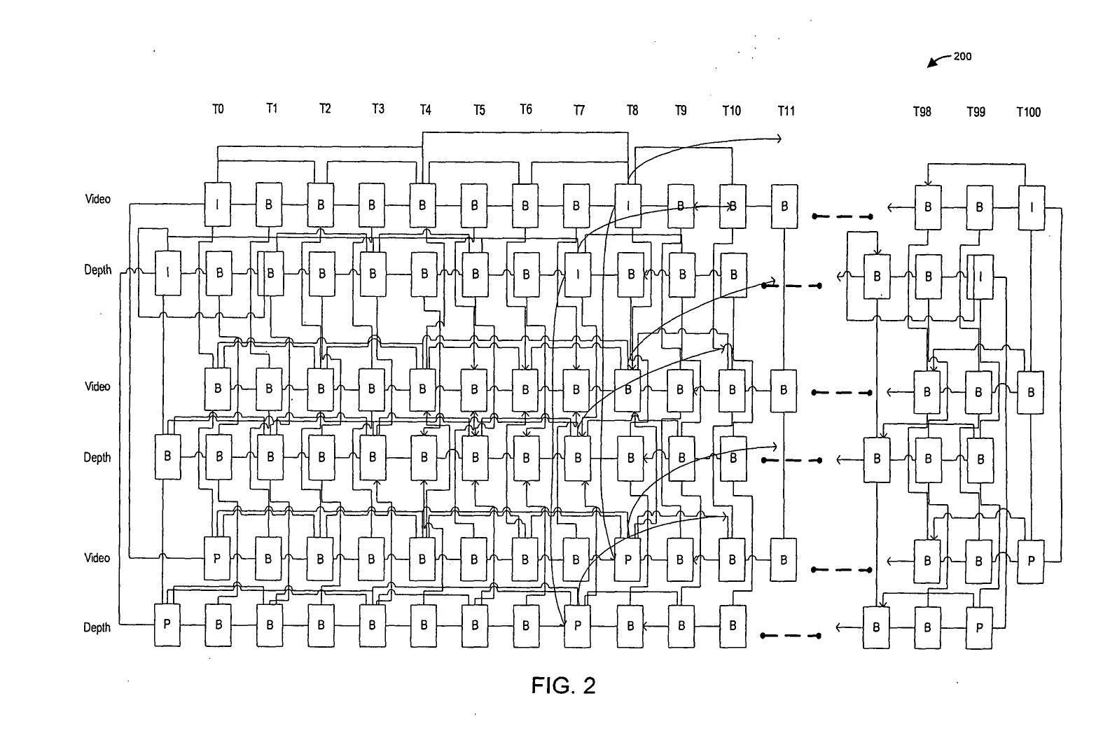

In at least one implementation, we propose to add depth within the multi-view video coding framework. The depth signal can also use a framework similar to that used for the video signal for each view. This can be done by considering depth as another set of video data and using the same set of tools that are used for video data. FIG. 2 shows another exemplary coding structure 200 for a multi-view video plus depth coding system with three views (shown from top to bottom, with the video and depth of a first view in the first 2 rows of pictures, followed by the video and depth of a second view in the middle two rows of pictures, followed by the video and depth of a third view in the bottom two rows of pictures), to which the present principles may be applied, in accordance with an implementation of the present principles.

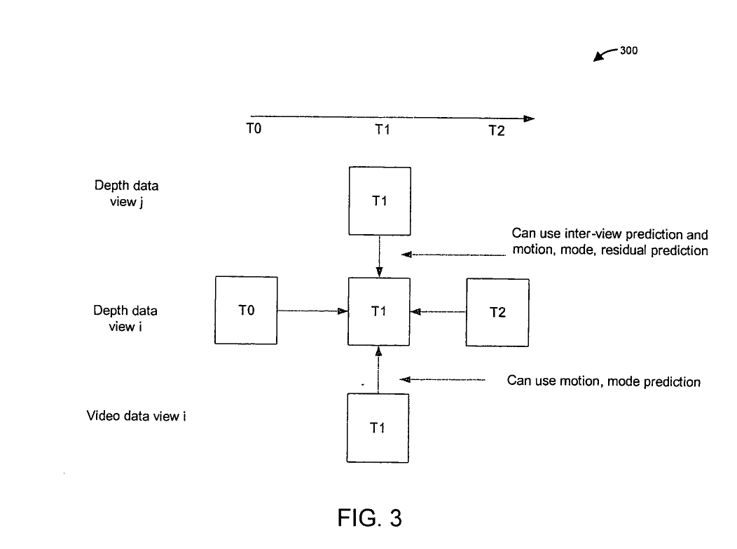

In the framework of the example, only the depth coding, and not the video coding, will use the information from the depth data for motion skip and inter-view prediction. The intention of this particular implementation is to code the depth data independently from the video signal. However, motion skip and inter-view prediction can be applied to a depth signal in an analogous manner that they are applied to a video signal. In order to improve the coding efficiency of the coding depth data, we propose that the depth data of a view i can not only use the side information, such as inter-view prediction and motion information (motion skip mode), view synthesis information, and so forth from other depth data of view j but also can use such side information from the associated video data corresponding to view i. FIG. 3 shows a prediction 300 of depth data of view i. T0, T1 and T2 correspond to different time instances. Although shown that the depth of view i can predict only from same time instance when predicting from video data of view i and depth data of view j, this is just one embodiment. Other systems may choose to use any time instance. Additionally, other systems and implementations may predict depth data of view i from a combination of information from depth data and/or video data from various views and time instances.

In order to indicate whether the depth data for view i uses motion, mode and other prediction information from its associated video data view i or from depth data of another view j, we propose to indicate the same using a syntax element. The syntax element may be, for example, signaled at the macroblock level and is conditioned on the current network abstraction layer (NAL) unit belonging to the depth data. Of course, such signaling may occur at another level, while maintaining the spirit of the present principles.

TABLE 2 shows syntax elements for the macroblock layer for motion skip mode, in accordance with an implementation.

TABLE 2

| | | |
|---|---|---|
| macroblock_layer( ) { | C | Descriptor |

if ( ! anchor_pic_flag ) {

i = InverseViewID( view_id )
if( (num_non_anchor_ref_I0[i] > 0) ∥( num_non_anchor_ref_I1[i] > 0) &&

motion_skip_enable_flag )

| | | |
|---|---|---|
| motion_skip_flag | 2 | u(1) \| ae(v) |

if(depth_flag)

| | | |
|---|---|---|
| depth_data | 2 | u(1) \| ae(v) |

}

if (! motion_skip_flag) {

| | | |
|---|---|---|
| Mb_type | 2 | ue(v) \| ae(v) |
| if( mb_type = = I_PCM ) { | | |

while( !byte_aligned( ) )

| | | |
|---|---|---|
| pcm_alignment_zero_bit | 2 | f(1) |

for(i = 0; i < 256; i++ )

| | | |
|---|---|---|
| pcm_sample_luma[i] | 2 | u(v) |

for( i = 0; i < 2 * MbWidthC * MbHeightC; i++ )

| | | |
|---|---|---|
| pcm_sample_chroma[i] | 2 | u(v) |

} else {

noSubMbPartSizeLessThan8x8Flag = 1
if( mb_type != I_NxN &&

| | |
|---|---|
| MbPartPredMode( mb_type, 0 ) != Intra_16x16 && | |
| NumMbPart( mb_type ) = = 4 ) { | |
| sub_mb_pred( mb_type ) | 2 |
| for( mbPartIdx = 0; mbPartIdx < 4; mbPartIdx++ ) | |

if( sub_mb_type[ mbPartIdx ] != B_Direct_8x8 ) {

if( NumSubMbPart( sub_mb_type[ mbPartIdx ] ) > 1 )

noSubMbPartSizeLessThan8x8Flag = 0

} else if( !direct_8x8_inference_flag )

noSubMbPartSizeLessThan8x8Flag = 0

} else {

if( transform_8x8_mode_flag && mb_type = = I_NxN )

| | | |
|---|---|---|
| transform_size_8x8_flag | 2 | u(1) \| ae(v) |

| | |
|---|---|
| mb_pred( mb_type ) | 2 |

}

}
if( MbPartPredMode( mb_type, 0 ) != Intra_16x16 ) {

| | | |
|---|---|---|
| coded_block_pattern | 2 | me(v) \| ae(v) |
| if( CodedBlockPatternLuma > 0 && | | |

| | | |
|---|---|---|
| transform_8x8_mode_flag && mb_type != I_NxN && | | |
| noSubMbPartSizeLessThan8x8Flag && | | |
| ( mb_type != B_Direct_16x16 \| \| direct_8x8_inference_flag)) | | |
| transform_ size_8x8_flag | 2 | u(1) \| ae(v) |

}
if( CodedBlockPatternLuma > 0 | | CodedBlockPatternChroma > 0 | |

| | | |
|---|---|---|
| MbPartPredMode( mb_type, 0 ) = = Intra_16x16 ) { | | |
| mb_qp_delta | 2 | se(v) \| ae(v) |
| residual( ) | 3 \| 4 | |

}

}

}

In an implementation, for example, such as that corresponding to TABLE 2, the syntax depth_data has the following semantics:

depth_data equal to 0 indicates that the current macroblock should use the video data corresponding to the current depth data for motion prediction for current macroblock.

depth_data equal to 1 indicates that the current macroblock should use the depth data corresponding to the depth data of another view as indicated in the dependency structure for motion prediction.

Additionally, the depth data and video data may have different resolutions. Some views may have the video data sub-sampled while other views may have their depth data sub-sampled or both. If this is the case, then the interpretation of the depth_data flag depends on the resolution of the reference pictures. In cases where the resolution is different we can use the same method as that used for the scalable video coding (SVC) extension to the H.264/AVC Standard for the derivation of motion information. In SVC, if the resolution in the enhancement layer is an integer multiple of the resolution of the base layer, the encoder will choose to perform motion and mode inter-layer prediction by upsampling to the same resolution first, then doing motion compensation.

If the reference picture (depth or video) has a resolution lower than the current depth picture being coded, then the encoder may choose not to perform motion and mode interpretation from that reference picture.

There are several methods in which depth information can be transmitted to a decoder. Several of these methods are described below for illustrative purposes. However, it is to be appreciated that the present principles are not limited to solely the following methods and, thus, other methods may be used to transmit depth information to a decoder, while maintaining the spirit of the present principles.

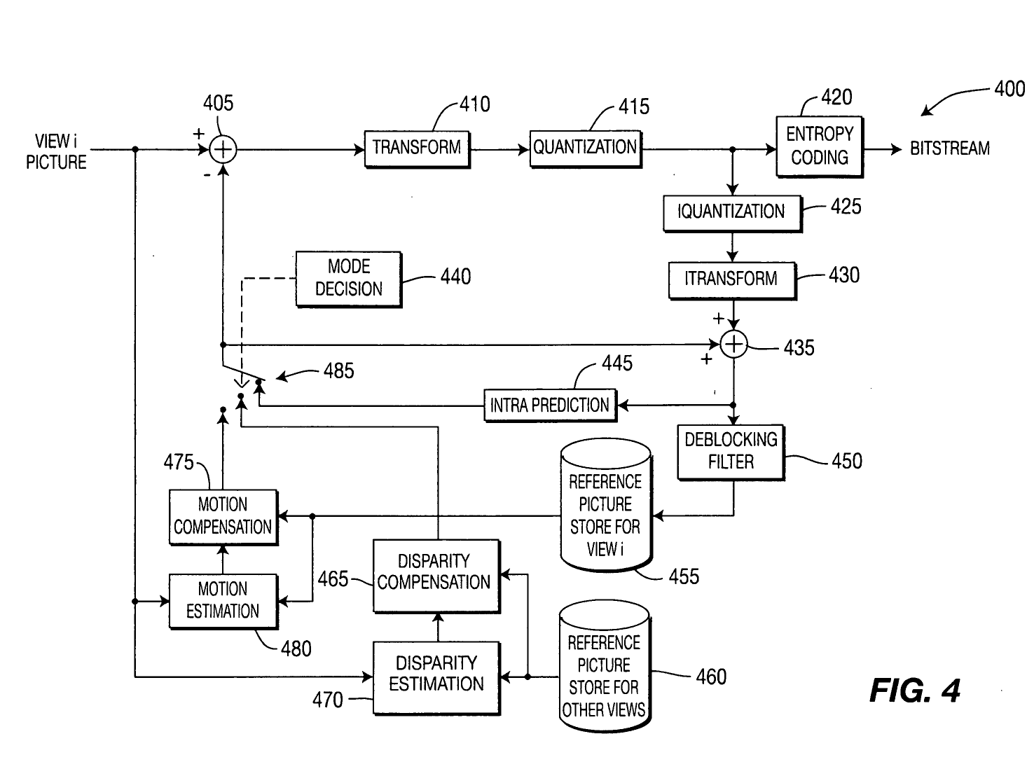

FIG. 4 shows an exemplary Multi-view Video Coding (MVC) encoder 400, to which the present principles may be applied, in accordance with an implementation of the present principles. The encoder 400 includes a combiner 405 having an output connected in signal communication with an input of a transformer 410. An output of the transformer 410 is connected in signal communication with an input of quantizer 415. An output of the quantizer 415 is connected in signal communication with an input of an entropy coder 420 and an input of an inverse quantizer 425. An output of the inverse quantizer 425 is connected in signal communication with an input of an inverse transformer 430. An output of the inverse transformer 430 is connected in signal communication with a first non-inverting input of a combiner 435. An output of the combiner 435 is connected in signal communication with an input of an intra predictor 445 and an input of a deblocking filter 450. An output of the deblocking filter 450 is connected in signal communication with an input of a reference picture store 455 (for view An output of the reference picture store 455 is connected in signal communication with a first input of a motion compensator 475 and a first input of a motion estimator 480. An output of the motion estimator 480 is connected in signal communication with a second input of the motion compensator 475.

An output of a reference picture store 460 (for other views) is connected in signal communication with a first input of a disparity/illumination estimator 470 and a first input of a disparity/illumination compensator 465. An output of the disparity/illumination estimator 470 is connected in signal communication with a second input of the disparity/illumination compensator 465.

An output of the entropy decoder 420 is available as an output of the encoder 400. A non-inverting input of the combiner 405 is available as an input of the encoder 400, and is connected in signal communication with a second input of the disparity/illumination estimator 470, and a second input of the motion estimator 480. An output of a switch 485 is connected in signal communication with a second non-inverting input of the combiner 435 and with an inverting input of the combiner 405. The switch 485 includes a first input connected in signal communication with an output of the motion compensator 475, a second input connected in signal communication with an output of the disparity/illumination compensator 465, and a third input connected in signal communication with an output of the intra predictor 445.

A mode decision module 440 has an output connected to the switch 485 for controlling which input is selected by the switch 485.

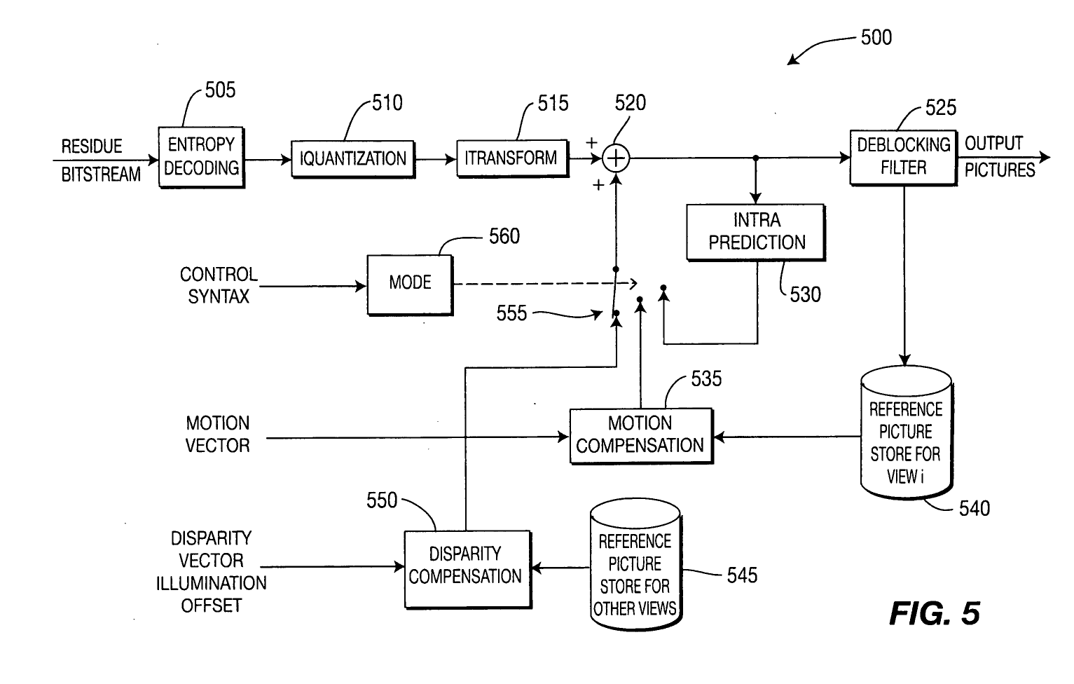

FIG. 5 shows an exemplary Multi-view Video Coding (MVC) decoder, to which the present principles may be applied, in accordance with an implementation of the present principles. The decoder 500 includes an entropy decoder 505 having an output connected in signal communication with an input of an inverse quantizer 510. An output of the inverse quantizer is connected in signal communication with an input of an inverse transformer 515. An output of the inverse transformer 515 is connected in signal communication with a first non-inverting input of a combiner 520. An output of the combiner 520 is connected in signal communication with an input of a deblocking filter 525 and an input of an intra predictor 530. An output of the deblocking filter 525 is connected in signal communication with an input of a reference picture store 540 (for view i). An output of the reference picture store 540 is connected in signal communication with a first input of a motion compensator 535.

An output of a reference picture store 545 (for other views) is connected in signal communication with a first input of a disparity/illumination compensator 550.

An input of the entropy coder 505 is available as an input to the decoder 500, for receiving a residue bitstream. Moreover, an input of a mode module 560 is also available as an input to the decoder 500, for receiving control syntax to control which input is selected by the switch 555. Further, a second input of the motion compensator 535 is available as an input of the decoder 500, for receiving motion vectors. Also, a second input of the disparity/illumination compensator 550 is available as an input to the decoder 500, for receiving disparity vectors and illumination compensation syntax.

An output of a switch 555 is connected in signal communication with a second non-inverting input of the combiner 520. A first input of the switch 555 is connected in signal communication with an output of the disparity/illumination compensator 550. A second input of the switch 555 is connected in signal communication with an output of the motion compensator 535. A third input of the switch 555 is connected in signal communication with an output of the intra predictor 530. An output of the mode module 560 is connected in signal communication with the switch 555 for controlling which input is selected by the switch 555. An output of the deblocking filter 525 is available as an output of the decoder.

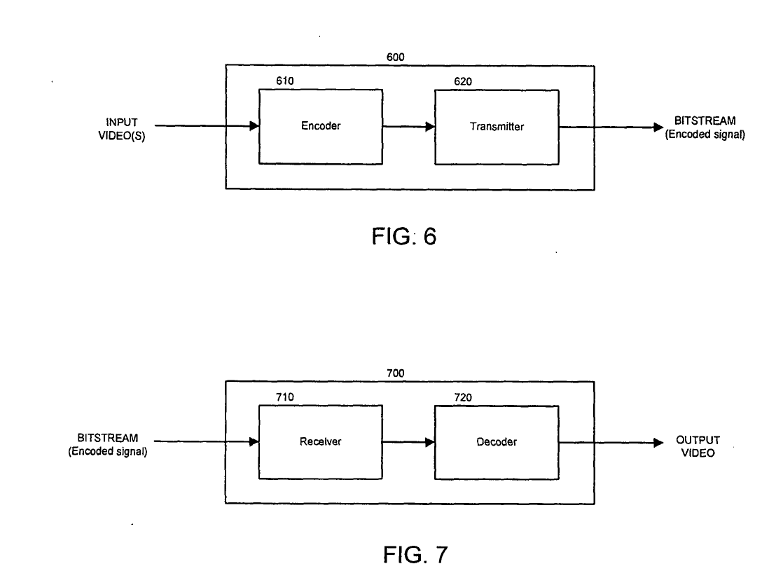

FIG. 6 shows a video transmission system 600, to which the present principles may be applied, in accordance with an implementation of the present principles. The video transmission system 600 may be, for example, a head-end or transmission system for transmitting a signal using any of a variety of media, such as, for example, satellite, cable, telephone-line, or terrestrial broadcast. The transmission may be provided over the Internet or some other network.

The video transmission system 600 is capable of generating and delivering video content including video and depth information. This is achieved by generating an encoded signal(s) including video and depth information.

The video transmission system 600 includes an encoder 610 and a transmitter 620 capable of transmitting the encoded signal. The encoder 610 receives video information and depth information and generates an encoded signal(s) therefrom. The encoder 610 may be, for example, the encoder 300 described in detail above.

The transmitter 620 may be, for example, adapted to transmit a program signal having one or more bitstreams representing encoded pictures and/or information related thereto. Typical transmitters perform functions such as, for example, one or more of providing error-correction coding, interleaving the data in the signal, randomizing the energy in the signal, and modulating the signal onto one or more carriers. The transmitter may include, or interface with, an antenna (not shown).

FIG. 7 shows a diagram of an implementation of a video receiving system 700. The video receiving system 700 may be configured to receive signals over a variety of media, such as, for example, satellite, cable, telephone-line, or terrestrial broadcast. The signals may be received over the Internet or some other network.

The video receiving system 700 may be, for example, a cell-phone, a computer, a set-top box, a television, or other device that receives encoded video and provides, for example, decoded video for display to a user or for storage. Thus, the video receiving system 700 may provide its output to, for example, a screen of a television, a computer monitor, a computer (for storage, processing, or display), or some other storage, processing, or display device.

The video receiving system 700 is capable of receiving and processing video content including video and depth information. This is achieved by receiving an encoded signal(s) including video and depth information.

The video receiving system 700 includes a receiver 710 capable of receiving an encoded signal, such as for example the signals described in the implementations of this application, and a decoder 720 capable of decoding the received signal.

The receiver 710 may be, for example, adapted to receive a program signal having a plurality of bitstreams representing encoded pictures. Typical receivers perform functions such as, for example, one or more of receiving a modulated and encoded data signal, demodulating the data signal from one or more carriers, de-randomizing the energy in the signal, de-interleaving the data in the signal, and error-correction decoding the signal. The receiver 710 may include, or interface with, an antenna (not shown).

The decoder 720 outputs video signals including video information and depth information. The decoder 720 may be, for example, the decoder 400 described in detail above.

### Embodiment 1

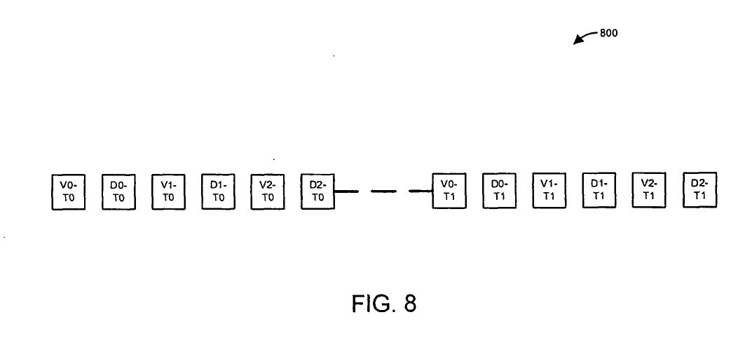

Depth can be interleaved with the video data in such a way that after video data of view i, its associated depth data follows. FIG. 8 shows an ordering 800 of view and depth data. In this case, one access unit can be considered to include video and depth data for all the views at a given time instance. In order to differentiate between video and depth data for a network abstraction layer unit, we propose to add a syntax element, for example, at the high level, which indicates that the slice belongs to video or depth data. This high level syntax can be present in the network abstraction layer unit header, the slice header, the sequence parameter set (SPS), the picture parameter set (PPS), a supplemental enhancement information (SEI) message, and so forth. One embodiment of adding this syntax in the network abstraction layer unit header is shown in TABLE 3. In particular, TABLE 3 shows a network abstraction layer unit header for the MVC Specification, in accordance with an implementation.

TABLE 3

| | | |
|---|---|---|
| nal_unit_header_svc_mvc_extension( ) { | C | Descriptor |

| | | |
|---|---|---|
| svc_mvc_flag | All | u(1) |
| If (!svc_mvc_flag) { | | |

| | | |
|---|---|---|
| idr_flag | All | u(1) |
| priority_id | All | u(6) |
| no_inter_layer_pred_flag | All | u(1) |
| dependency_id | All | u(3) |
| quality_id | All | u(4) |
| temporal_id | All | u(3) |
| use_base_prediction_flag | All | u(1) |
| discardable_flag | All | u(1) |
| output_flag | All | u(1) |
| reserved_three_2bits | All | u(2) |

} else {

| | | |
|---|---|---|
| priority_id | All | u(6) |
| temporal_id | All | u(3) |
| anchor_pic_flag | All | u(1) |
| view_id | All | u(10) |
| idr_flag | All | u(1) |
| inter_view_flag | All | u(1) |
| depth_flag | All | u(1) |

}

nalUnitHeaderBytes += 3

}

In an embodiment, for example, such as that corresponding to TABLE 2, the syntax element depth_flag may have the following semantics:

depth_flag equal to 0 indicates that the network abstraction layer unit includes video data.

depth_flag equals to 1 indicates that the NAL unit includes depth data.

Other implementations may be tailored to other standards for coding, or to no standard in particular. Implementations may organize the video and depth data so that for a given unit of content, the depth data follows the video data, or vice versa. A unit of content may be, for example, a sequence of pictures from a given view, a single picture from a given view, or a sub-picture portion (for example, a slice, a macroblock, or a sub-macroblock portion) of a picture from a given view. A unit of content may alternatively be, for example, pictures from all available views at a given time instance.

### Embodiment 2

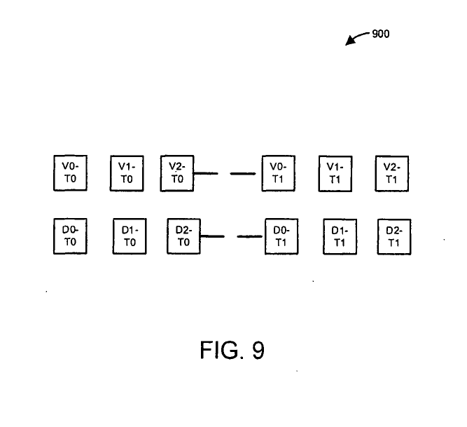

Depth may be sent independent of the video signal. FIG. 9 shows another ordering 900 of view and depth data. The proposed high level syntax change in TABLE 2 can still be applied in this case. It is to be noted that the depth data is still sent as part of the bitstream with the video data (although other implementations send depth data and video data separately). The interleaving may be such that the video and depth are interleaved for each time instance.

Embodiments 1 and 2 are considered to involve the in-band transmission of depth data since depth is transmitted as part of the bitstream along with video data. Embodiment 2 produces 2 streams (one for video and one for depth) that may be combined at a system or application level. Embodiment 2 thus allows for a variety of different configurations of video and depth data in the combined stream. Further, the 2 separate streams may be processed differently, providing for example additional error correction for depth data (as compared to the error correction for video data) in applications in which the depth data is critical.

### Embodiment 3

Depth data may not be required for certain applications that do not support the use of depth. In such cases, the depth data can be sent out-of-band. This means that the video and depth data are decoupled and sent via separate channels over any medium. The depth data is only necessary for applications that perform view synthesis using this depth data. As a result, even if the depth data does not arrive at the receiver for such applications, the applications can still function normally.

In cases where the depth data is used, for example, but not limited to, FTV and immersive teleconferencing, the reception of the depth data (which is sent out-of-band) can be guaranteed so that the application can use the depth data in a timely manner.

### Coding Depth Data as a Video Data Component

The video signal is presumed to be composed of luminance and chroma data, which is the input for video encoders. Different from our first scheme, we propose to treat a depth map as an additional component of the video signal. In the following, we propose to adapt H.264/AVC to include a depth map as input in addition to the luminance and chroma data. It is to be appreciated that this approach can be applied to other standards, video encoder, and/or video decoders, while maintaining the spirit of the present principles. In particular implementations, the video and the depth are in the same NAL unit.

### Embodiment 4

Like chroma components, depth may be sampled at locations other than luminance component. In one implementation, depth can be sampled at 4:2:0, 4:2:2 and 4:4:4. Similar to the 4:4:4 profile in H.264/AVC, the depth component can be independently coded with the luma/chroma component (independent mode), or can be coded in combination with the luma/chroma component (combined mode). To facilitate the feature, a modification in the sequence parameter set is proposed as shown by TABLE 4. In particular, TABLE 4 shows a modified sequence parameter set capable of indicating the depth sampling format, in accordance with an implementation.

TABLE 4

| seq_parameter_set_rbsp( ) { | | C | Descriptor |
|---|---|---|---|
| | profile_idc | 0 | u(8) |
| | constraint_set0_flag | 0 | u(1) |
| | constraint_set1_flag | 0 | u(1) |
| | constraint_set2_flag | 0 | u(1) |
| | constraint_set3_flag | 0 | u(1) |
| | reserved_zero_4bits /* equal to 0 */ | 0 | u(4) |
| | level_idc | 0 | u(8) |
| | seq_parameter_set_id | 0 | ue(v) |
| | if( profile_idc = = 100 \| \| profile_idc = = 110 \| \| | | |

| | | |
|---|---|---|
| profile_idc = = 122 \| \| profile_idc == 144 ) { | | |
| chroma_format_idc | 0 | ue(v) |
| if( chroma_format_idc = = 3 ) | | |

| | | |
|---|---|---|
| residual_colour_transform_flag | 0 | u(1) |

| | | |
|---|---|---|
| bit_depth_luma_minus8 | 0 | ue(v) |
| bit_depth_chroma_minus8 | 0 | ue(v) |
| qpprime_y_zero_transform_bypass_flag | 0 | u(1) |
| seq_scaling_matrix_present_flag | 0 | u(1) |
| if( seq_scaling_matrix_present_flag ) | | |

for( i = 0; i < 8; i++ ) {

| | | |
|---|---|---|
| seq_scaling_list_present_flag[ i ] | 0 | u(1) |
| if( seq_scaling_list_present_flag[ i ] ) | | |

if( i < 6 )

| | |
|---|---|
| scaling_list( ScalingList4x4[ i ], 16, | 0 |

UseDefaultScalingMatrix4x4Flag[ i ])

Else

| | |
|---|---|
| scaling_list( ScalingList8x8[ i − 6 ], 64, | 0 |

UseDefaultScalingMatrix8x8Flag[ i − 6 ] )

}

| | | |
|---|---|---|
| } | | |
| depth_format_idc | 0 | ue(v) |
| ... | | |
| rbsp_trailing_bits( ) | 0 | |

}

The semantics of the depth_format_idc syntax element is as follows:

depth_format_idc specifies the depth sampling relative to the luma sampling as the chroma sampling locations. The value of depth_format_idc shall be in the range of 0 to 3, inclusive. When depth_format_idc is not present, it shall be inferred to be equal to 0 (no depth map presented). Variables of SubWidthD and SubHeightD are specified in TABLE 5 depending on the depth sampling format, which is specified through depth_format_idc.

TABLE 5

| | | SubWidth | SubHeight |
|---|---|---|---|
| depth_format_idc | Depth Format | D | D |
| 0 | 2D | — | — |
| 1 | 4:2:0 | 2 | 2 |
| 2 | 4:2:2 | 2 | 1 |
| 3 | 4:4:4 | 1 | 1 |

In this embodiment, the depth_format_idc and chroma_format_idc should have the same value and are not equal to 3, such that the depth decoding is similar to the decoding of the chroma components. The coding modes including the predict mode, as well as the reference list index, the reference index, and the motion vectors, are all derived from the chroma components. The syntax coded_block_pattern should be extended to indicate how the depth transform coefficients are coded. One example is to use the following formulas.

CodedBlockPatternLuma=coded_block_pattern % 16

CodedBlockPatternChroma=(coded_block_pattern/16) % 4

CodedBlockPatternDepth=(coded_block_pattern/16)/4

A value 0 for CodedBlockPatternDepth means that all depth transform coefficient levels are equal to 0. A value 1 for CodedBlockPatternDepth means that one or more depth DC transform coefficient levels shall be non-zero valued, and all depth AC transform coefficient levels are equal to 0. A value 2 for CodedBlockPatternDepth means that zero or more depth DC transform coefficient levels are non-zero valued, and one or more depth AC transform coefficient levels shall be non-zero valued. Depth residual is coded as shown in TABLE 5.

TABLE 5

| | | |
|---|---|---|
| residual( ) { | C | Descriptor |

...
if( chroma_format_idc != 0 ) {

...

}
if( depth_format_idc != 0 ) {

NumD8x8 = 4 / (SubWidthD * SubHeightD )

if( CodedBlockPatternDepth & 3 ) /* depth DC residual present */

| | |
|---|---|
| residual_block( DepthDCLevel, 4 * NumD8x8 ) | 3 \| 4 |

Else

for( i = 0; i < 4 * NumD8x8; i++ )

DepthDCLevel[ i ] = 0

for( i8x8 = 0, i8x8 < NumD8x8; i8x8++ )

for( i4x4 = 0; i4x4 < 4; i4x4++ )

if( CodedBlockPatternDepth & 2 ) /* depth AC residual present */

| | |
|---|---|
| residual_block( DepthACLevel[ i8x8*4+i4x4 ], 15) | 3 \| 4 |

Else

for( i = 0; i < 15; i++ )

DepthACLevel[ i8x8*4+i4x4 ][ i ] = 0

}

}

### Embodiment 5

In this embodiment, the depth_format_idc is equal to 3, that is, the depth is sampled at the same locations as luminance. The coding modes including the predict mode, as well as the reference list index, the reference index, and the motion vectors, are all derived from the luminance components. The syntax coded_block_pattern can be extended in the same way as in Embodiment 4.

### Embodiment 6

In the embodiments 4 and 5, the motion vectors are set to either the same as luma component or chroma components. The coding efficiency may be improved if the motion vectors can be refined based on the depth data. The motion refinement vector is signaled as shown in TABLE 6. Refinement may be performed using any of a variety of techniques known, or developed, in the art.

TABLE 6

| macroblock_layer( ) { | | C | Descriptor |
|---|---|---|---|
| | mb_type | 2 | ue(v) \| ae(v) |
| | if( mb_type = = I_PCM ) { | | |

while( !byte_aligned( ) )

| | | |
|---|---|---|
| pcm_alignment_zero_bit | 2 | f(1) |

for( i = 0; i < 256; i++ )

| | | |
|---|---|---|
| pcm_sample_luma[ i ] | 2 | u(v) |

for( i = 0; i < 2 * MbWidthC * MbHeightC; i++ )

| | | |
|---|---|---|
| pcm_sample_chroma[ i ] | 2 | u(v) |

} else {

noSubMbPartSizeLessThan8x8Flag = 1
if( mb_type != I_NxN &&

| | | |
|---|---|---|
| depth_format_idc != 0 ) { | | |
| depth_motion_refine_flag | 2 | u(1) \| ae(v) |
| if (depth_motion_refine_flag) { | | |

| | | |
|---|---|---|
| motion_vector_refinement_list0_x | 2 | se(v) |
| motion_vector_refinement_list0_y | 2 | se(v) |
| if ( slice_type = = B ) { | | |

| | | |
|---|---|---|
| motion_vector_refinement_list1_x | 2 | se(v) |
| motion_vector_refinement_list1_y | 2 | se(v) |

}

}

)
if( mb_type != I_NxN &&

| | |
|---|---|
| MbPartPredMode( mb_type, 0) != Intra_16x16 && | |
| NumMbPart( mb_type ) = = 4 ) { | |
| sub_mb_pred( mb_type ) | 2 |
| for( mbPartIdx = 0; mbPartIdx < 4; mbPartIdx++ ) | |

if( sub_mb_type[ mbPartIdx ] != B_Direct_8x8 ) {

if( NumSubMbPart( sub_mb_type[ mbPartIdx ] ) > 1 )

noSubMbPartSizeLessThan8x8Flag = 0

} else if( !direct_8x8_inference_flag )

noSubMbPartSizeLessThan8x8Flag = 0

} else {

if( transform_8x8_mode_flag && mb_type = = I_NxN )

| | | |
|---|---|---|
| transform_size_8x8_flag | 2 | u(1) \| ae(v) |

| | |
|---|---|
| mb_pred( mb_type ) | 2 |

}

...

}

The semantics for the proposed syntax are as follows:

depth_motion_refine_flag indicates if the motion refinement is enabled for current macroblock. A value of 1 means the motion vector copied from the luma component will be refined. Otherwise, no refinement on the motion vector will be performed.

motion_refinementlist0_x, motion_refinementlist0_y, when present, indicate that the LIST0 motion vector will be added by the signaled refinement vector, if depth_motion_refine is set for current macroblock.

motion_refinementlist1x, motion_refinementlist1_y, when present, indicate that the LIST1 motion vector will be added by the signaled refinement vector, if depth_motion_refine is set for current macroblock.

Note that portions of the TABLES that are discussed above are generally indicated in the TABLES using italicized type.

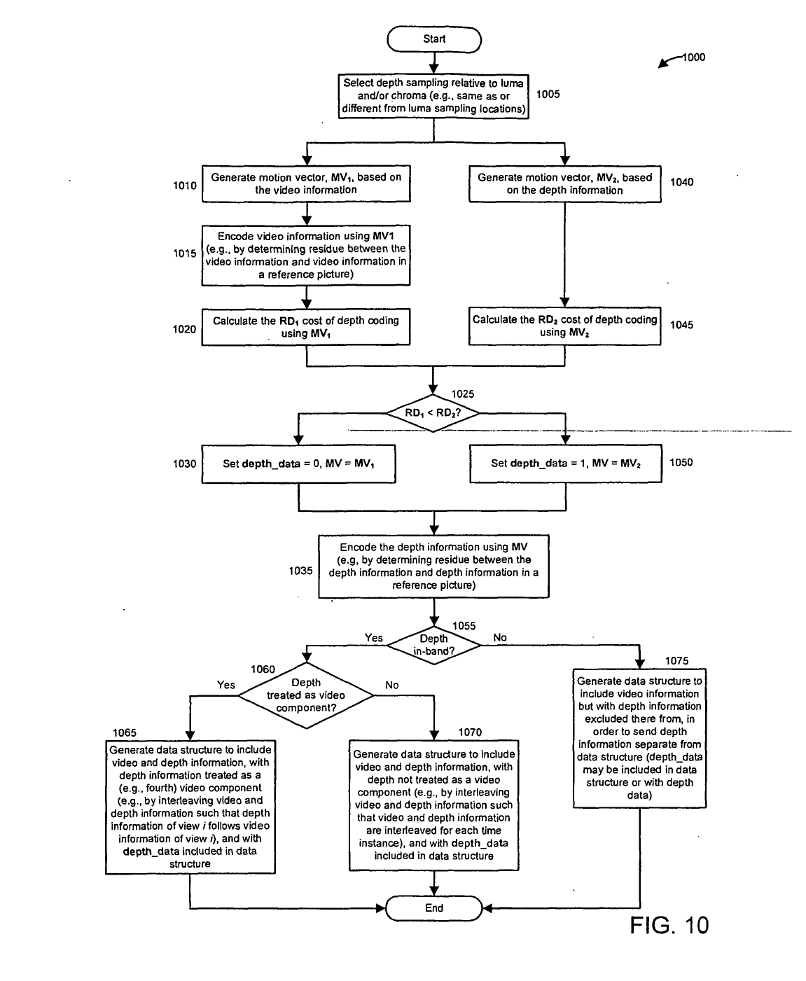

FIG. 10 shows a method 1000 for encoding video and depth information, in accordance with an implementation of the present principles. At S1005 (note that the “S” refers to a step, which is also referred to as an operation, so that “S1005” can be read as “Step 1005”), a depth sampling relative to luma and/or chroma is selected. For example, the selected depth sampling may be the same as or different from the luma sampling locations. At S1010, the motion vector MV₁ is generated based on the video information. At S1015, the video information is encoded using motion vector MV₁. At S1020, the rate distortion cost RD, of depth coding using MV₁ is calculated.

At S1040, the motion vector MV₂ is generated based on the video information. At S1045, the rate distortion cost RD, of depth coding using MV₁ is calculated.

At S1025, it is determined whether RD, is less than RD₂. If so, then control is passed to S1030. Otherwise, control is passed to S1050.

At S1030, depth_data is set to 0, and MV is set to MV₁.

At S1050, depth_data is set to 1, and MV is set to MV₂.

“Depth_data” may be referred to as a flag, and it tells you what motion vector you are using. So, depth_data equal to 0 means that we should use the motion vector from the video data. That is, the video data corresponding to the current depth data is used for motion prediction for the current macroblock.

And depth_data equal to 1 means that we should use the motion vector from the depth data. That is, the depth data of another view, as indicated in the dependency structure for motion prediction, is used for the motion prediction for the current macroblock.

At S1035, the depth information is encoded using MV (depth_data is encapsulated in the bitstream). At S1055, it is determined whether or not depth is to be transmitted in-band. If so, then control is passed to S1060. Otherwise, control is passed to S1075.

At S1060, it is determined whether or not depth is to be treated as a video component. If so, then control is passed to S1065. Otherwise, control is passed to S1070.

At S1065, a data structure is generated to include video and depth information, with the depth information treated as a (for example, fourth) video component (for example, by interleaving video and depth information such that the depth data of view i follows the video data of view i), and with depth_data included in the data structure. The video and depth are encoded on a macroblock level.

At S1070, a data structure is generated to include video and depth information, with the depth information not treated as a video component (for example, by interleaving video and depth information such that the video and depth information are interleaved for each time instance), and with depth_data included in the data structure.

At S1075, a data structure is generated to include video information but with depth information excluded there from, in order to send depth information separate from the data structure. Depth_data may be included in the data structure or with the separate depth data. Note that the video information may be included in any type of formatted data, whether referred to as a data structure or not. Further, another data structure may be generated to include the depth information. The depth data may be sent out-of-band. Note that depth_data may be included with the video data (for example, within a data structure that includes the video data) and/or with the depth data (for example, within a data structure that includes the depth data).

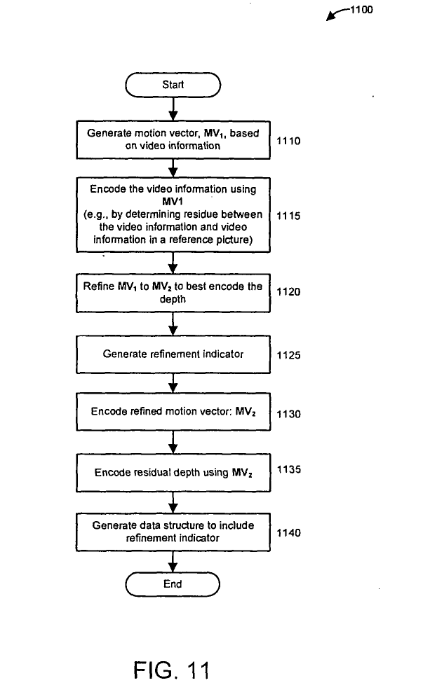

FIG. 11 shows a method for encoding video and depth information with motion vector refinement, in accordance with an implementation of the present principles. At S1110, a motion vector MV₁ is generated based on video information. At S1115, the video information is encoded using MV₁ (for example, by determining residue between the video information and video information in a reference picture). At S1120, MV₁ is refined to MV₂ to best encode the depth. One example of refining a motion vector includes performing a localized search around the area pointed to by a motion vector to determine if a better match is found.

At S1125, a refinement indicator is generated. At S1130, the refined motion vector MV₂ is encoded. For example, the difference between MV₂ and MV₁ may be determined and encoded.

In one implementation, the refinement indicator is a flag that is set in the macroblock layer. Table 6 can be adapted to provide an example of how such a flag could be transmitted. Table 6 was presented earlier for use in an implementation in which depth was treated as a fourth dimension. However, Table 6 can also be used in different and broader contexts. In the present context, Table 6 can also be used, and the following semantics for the syntax can be used (instead or the semantics for the syntax originally proposed for Table 6). Further, in the semantics that follow for the reapplication of Table 6, if depth_motion_refine_flag is set to 1, the coded MV will be depicted as a refinement vector to the one copied from the video signal.

The semantics for the proposed syntax, for the reapplication of Table 6, are as follows:

depth_motion_refine_flag indicates if the motion refinement is enabled for current macroblock. A value of 1 means the motion vector copied from the video signal will be refined. Otherwise, no refinement on the motion vector will be performed.

motion_refinement_list0_x, motion_refinement_List0_y, when present, indicate that the LIST0 motion vector will be added by the signaled refinement vector, if depth_motion_refine is set for current macroblock.

motion_refinement_list1_x, motion_refinement_list1_y, when present, indicate that the LIST1 motion vector will be added by the signaled refinement vector, if depth_motion_refine is set for current macroblock.

Note that portions of the TABLES that are discussed above are generally indicated in the TABLES using italicized type.

At S1135, the residual depth is encoded using MV₂. This is analogous to the encoding of the video at S1115. At S1140, the data structure is generated to include the refinement indicator (as well as the video information and, optionally the depth information).

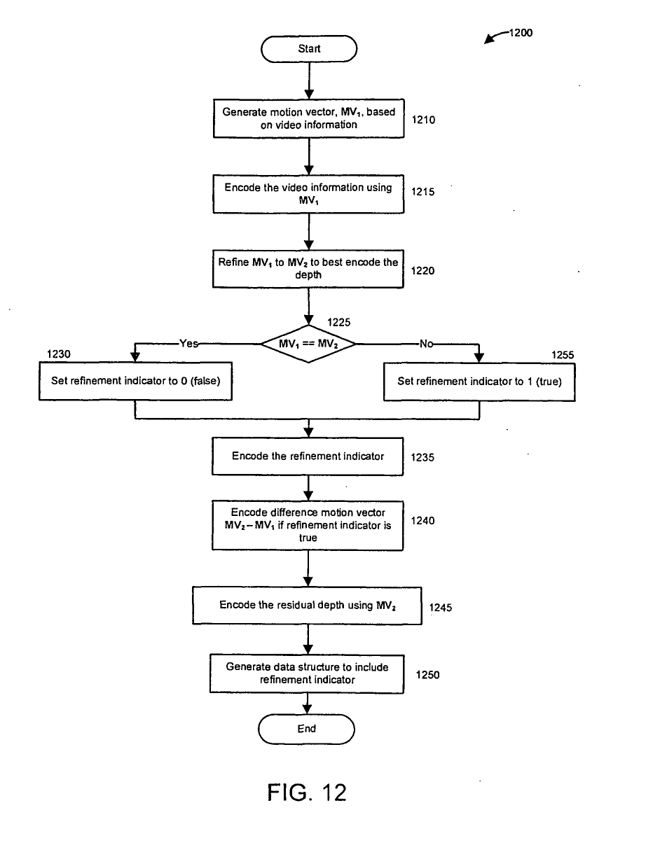

FIG. 12 shows a method for encoding video and depth information with motion vector refinement and differencing, in accordance with an implementation of the present principles. At S1210, a motion vector MV₁ is generated based on video information. At S1215, the video information is encoded using MV₁. At S1220, MV₁ is refined to MV₂ to best encode the depth. At S1225, it is determined whether or not MV₁ is equal to MV₂. If so, then control is passed to S1230. Otherwise, control is passed to S1255.

At S1230, the refine indicator is set to 0 (false).

At S1235, the refinement indicator is encoded. At S1240, a difference motion vector is encoded (MV₂-MV₁) if the refinement indicator is set to true (per S1255). At S1245, the residual depth is encoded using MV₂. At S1250, a data structure is generated to include the refinement indicator (as well as the video information and, optionally the depth information).

At S1255, the refinement indicator is set to 1 (true).

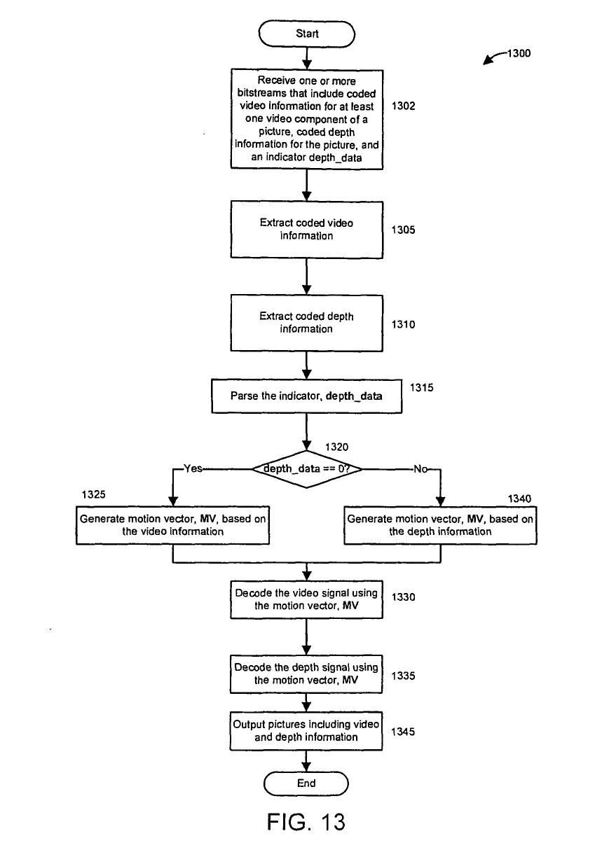

FIG. 13 shows a method for decoding video and depth information, in accordance with an implementation of the present principles. At S1302, one or more bitstreams are received that include coded video information for a video component of a picture, coded depth information for the picture, and an indicator depth_data (which signals if a motion vector is determined by the video information or the depth information). At S1305, the coded video information for the video component of the picture is extracted. At S1310, the coded depth information for the picture is extracted from the bitstream. At S1315, the indicator depth_data is parsed. At S1320, it is determined whether or not the depth_data is equal to 0. If so, then control is passed to S1325. Otherwise, control is passed to S1340.

At S1325, a motion vector MV is generated based on the video information.

At S1330, the video signal is decoded using the motion vector MV. At S1335, the depth signal is decoded using the motion vector MV. At S1340, pictures including video and depth information are output.

At S1340, the motion vector MV is generated based on the depth information.

Note that if a refined motion vector were used for encoding the depth information, then prior to S1335, the refinement information could be extracted and the refined MV generated. Then in S1335, the refined MV could be used.

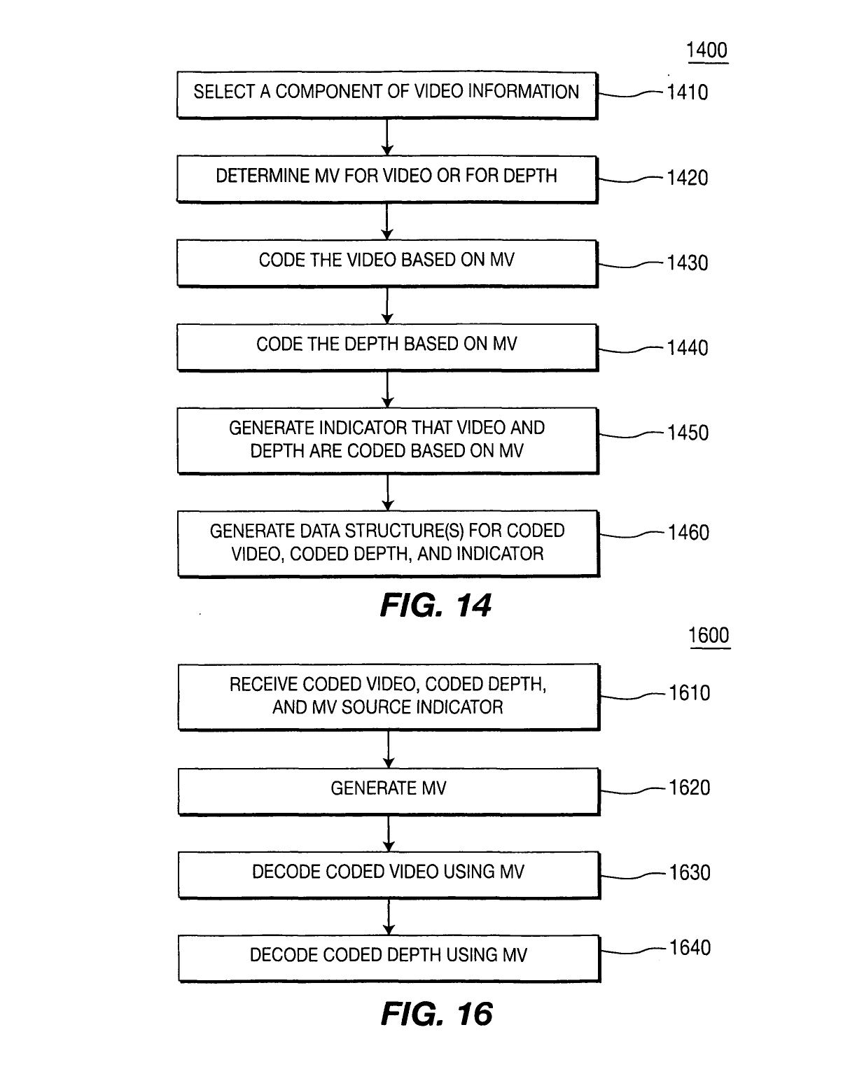

Referring to FIG. 14, a process 1400 is shown. The process 1400 includes selecting a component of video information for a picture (1410). The component may be, for example, luminance, chrominance, red, green, or blue.

The process 1400 includes determining a motion vector for the selected video information or for depth information for the picture (1420). Operation 1420 may be performed, for example, as described in operations 1010 and 1040 of FIG. 10.

The process 1400 includes coding the selected video information (1430), and the depth information (1440), based on the determined motion vector. Operations 1430 and 1440 may be performed, for example, as described in operations 1015 and 1035 of FIG. 10, respectively.

The process 1400 includes generating an indicator that the selected video information and the depth information are coded based on the determined motion vector (1450). Operation 1450 may be performed, for example, as described in operations 1030 and 1050 of FIG. 10.

The process 1400 includes generating one or more data structures that collectively include the coded video information, the coded depth information, and the generated indicator (1460). Operation 1460 may be performed, for example, as described in operations 1065 and 1070 of FIG. 10.

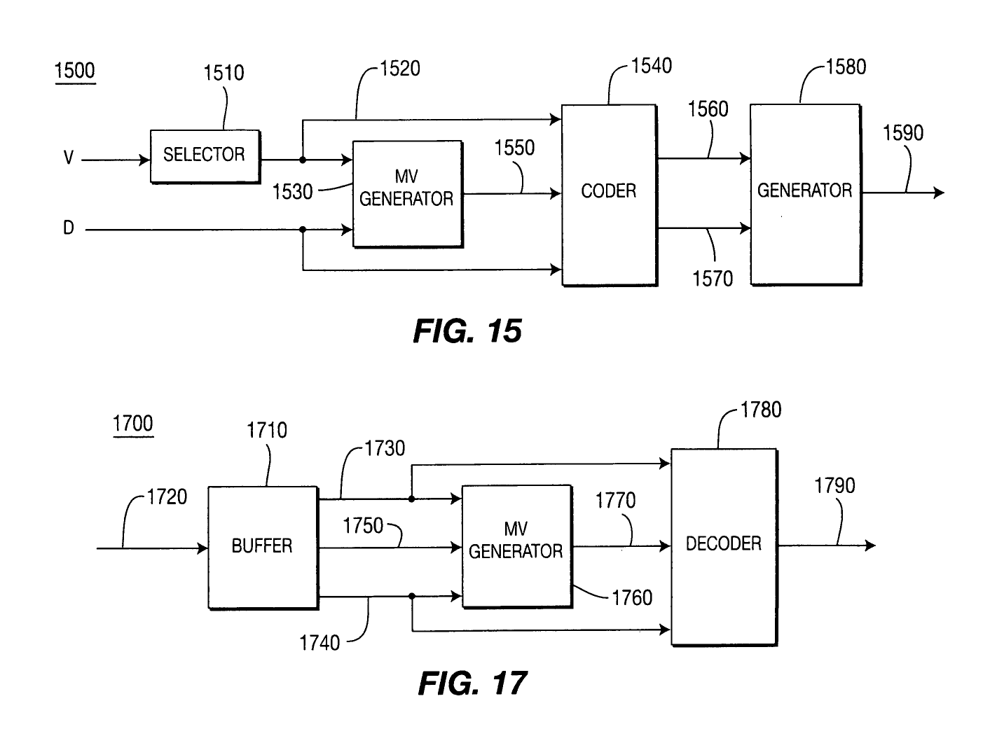

Referring to FIG. 15, an apparatus 1500, such as, for example, an H.264 encoder, is shown. An example of the structure and operation of the apparatus 1500 is now provided. The apparatus 1500 includes a selector 1510 that receives video to be encoded. The selector 1510 selects a component of video information for a picture, and provides the selected video information 1520 to a motion vector generator 1530 and a coder 1540. The selector 1510 may perform the operation 1410 of the process 1400.

The motion vector generator 1530 also receives depth information for the picture, and determines a motion vector for the selected video information 1520 or for the depth information. The motion vector generator 1530 may operate, for example, in an analogous manner to the motion estimation block 480 of FIG. 4. The motion vector generator 1530 may perform the operation 1420 of the process 1400. The motion vector generator 1530 provides a motion vector 1550 to the coder 1540.

The coder 1540 also receives the depth information for the picture. The coder 1540 codes the selected video information based on the determined motion vector, and codes the depth information based on the determined motion vector. The coder 1540 provides the coded video information 1560 and the coded depth information 1570 to a generator 1580. The coder 1540 may operate, for example, in an analogous manner to the blocks 410-435, 450, 455, and 475 in FIG. 4. Other implementations may, for example, use separate coders for coding the video and the depth. The coder 1540 may perform the operations 1430 and 1440 of the process 1400.

The generator 1580 generates an indicator that the selected video information and the depth information are coded based on the determined motion vector. The generator 1580 also generates one or more data structures (shown as an output 1590) that collectively include the coded video information, the coded depth information, and the generated indicator. The generator 1580 may operate, for example, in an analogous manner to the entropy coding block 420 in FIG. 4 which produces the output bitstream for the encoder 400. Other implementations may, for example, use separate generators to generate the indicator and the data structure(s). Further, the indicator may be generated, for example, by the motion vector generator 1530 or the coder 1540. The generator 1580 may perform the operations 1450 and 1460 of the process 1400.

Referring to FIG. 16, a process 1600 is shown. The process 1600 includes receiving data (1610). The data includes coded video information for a video component of a picture, coded depth information for the picture, and an indicator that the coded video information and the coded depth information are coded based on a motion vector determined for the video information or for the depth information. The indicator may be referred to as a motion vector source indicator, in which the source is either the video information or the depth information, for example. Operation 1610 may be performed, for example, as described for operation 1302 in FIG. 13.

The process 1600 includes generating the motion vector for use in decoding both the coded video information and the coded depth information (1620). Operation 1620 may be performed, for example, as described for operations 1325 and 1340 in FIG. 13.

The process 1600 includes decoding (1330) the coded video information based on the generated motion vector, to produce decoded video information for the picture (1630). The process 1600 also includes decoding (1335) the coded depth information based on the generated motion vector, to produce decoded depth information for the picture (1640). Operations 1630 and 1640 may be performed, for example, as described for operations 1330 and 1335 in FIG. 13, respectively.

Referring to FIG. 17, an apparatus 1700, such as, for example, an H.264 decoder, is shown. An example of the structure and operation of the apparatus 1700 is now provided. The apparatus 1700 includes a buffer 1710 configured to receive data that includes (1) coded video information for a video component of a picture, (2) coded depth information for the picture, and (3) an indicator that the coded video information and the coded depth information are coded based on a motion vector determined for the video information or for the depth information. The buffer 1710 may operate, for example, in an analogous manner to the entropy decoding block 505 of FIG. 5, which receives coded information. The buffer 1710 may perform the operation 1610 of the process 1600.

The buffer 1710 provides the coded video information 1730, the coded depth information 1740, and the indicator 1750 to a motion vector generator 1760 that is included in the apparatus 1700. The motion vector generator 1760 generates a motion vector 1770 for use in decoding both the coded video information and the coded depth information. Note that the motion vector generator 1760 may generate the motion vector 1770 in a variety of manners, including generating the motion vector 1770 based on previously received video and/or depth data, or by copying a motion vector already generated for previously received video and/or depth data. The motion vector generator 1760 may perform the operation 1620 of the process 1600. The motion vector generator 1760 provides the motion vector 1770 to a decoder 1780.

The decoder 1780 also receives the coded video information 1730 and the coded depth information 1740. The decoder 1780 is configured to decode the coded video information 1730 based on the generated motion vector 1770 to produce decoded video information for the picture. The decoder 1780 is further configured to decode the coded depth information 1740 based on the generated motion vector 1770 to produce decoded depth information for the picture. The decoded video and depth information are shown as an output 1790 in FIG. 17. The output 1790 may be formatted in a variety of manners and data structures. Further, the decoded video and depth information need not be provided as an output, or alternatively may be converted into another format (such as a format suitable for display on a screen) before being output. The decoder 1780 may operate, for example, in a manner analogous to blocks 510-525, 535, and 540 in FIG. 5 which decode received data. The decoder 1780 may perform the operations 1630 and 1640 of the process 1600.

There is thus provided a variety of implementations. Included in these implementations are implementations that, for example, (1) use information from the encoding of video data to encode depth data, (2) use information from the encoding of depth data to encode video data, (3) code depth data as a fourth (or additional) dimension or component along with the Y, U, and V of the video, and/or (4) encode depth data as a signal that is separate from the video data. Additionally, such implementations may be used in the context of the multi-view video coding framework, in the context of another standard, or in a context that does not involve a standard (for example, a recommendation, and so forth).

We thus provide one or more implementations having particular features and aspects. However, features and aspects of described implementations may also be adapted for other implementations. Implementations may signal information using a variety of techniques including, but not limited to, SEI messages, other high level syntax, non-high-level syntax, out-of-band information, datastream data, and implicit signaling. Accordingly, although implementations described herein may be described in a particular context, such descriptions should in no way be taken as limiting the features and concepts to such implementations or contexts.

Additionally, many implementations may be implemented in either, or both, an encoder and a decoder.

Reference in the specification to “one embodiment” or “an embodiment” or “one implementation” or “an implementation” of the present principles, as well as other variations thereof, mean that a particular feature, structure, characteristic, and so forth described in connection with the embodiment is included in at least one embodiment of the present principles. Thus, the appearances of the phrase “in one embodiment” or “in an embodiment” or “in one implementation” or “in an implementation”, as well any other variations, appearing in various places throughout the specification are not necessarily all referring to the same embodiment.

It is to be appreciated that the use of any of the following “/”, “and/or”, and “at least one of', for example, in the cases of “NB”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The implementations described herein may be implemented in, for example, a method or a process, an apparatus, or a software program. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Implementations of the various processes and features described herein may be embodied in a variety of different equipment or applications, particularly, for example, equipment or applications associated with data encoding and decoding. Examples of equipment include video coders, video decoders, video codecs, web servers, set-top boxes, laptops, personal computers, cell phones, PDAs, and other communication devices. As should be clear, the equipment may be mobile and even installed in a mobile vehicle.

Additionally, the methods may be implemented by instructions being performed by a processor, and such instructions (and/or data values produced by an implementation) may be stored on a processor-readable medium such as, for example, an integrated circuit, a software carrier or other storage device such as, for example, a hard disk, a compact diskette, a random access memory (“RAM”), or a read-only memory (“ROM”). The instructions may form an application program tangibly embodied on a processor-readable medium. Instructions may be, for example, in hardware, firmware, software, or a combination. Instructions may be found in, for example, an operating system, a separate application, or a combination of the two. A processor may be characterized, therefore, as, for example, both a device configured to carry out a process and a device that includes a processor-readable medium having instructions for carrying out a process.

As will be evident to one of skill in the art, implementations may produce a variety of signals formatted to carry information that may be, for example, stored or transmitted. The information may include, for example, instructions for performing a method, or data produced by one of the described implementations. For example, a signal may be formatted to carry as data the rules for writing or reading the syntax of a described embodiment, or to carry as data the actual syntax-values written by a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known.

A number of implementations have been described. Nevertheless, it will be understood that various modifications may be made. For example, elements of different implementations may be combined, supplemented, modified, or removed to produce other implementations. Additionally, one of ordinary skill will understand that other structures and processes may be substituted for those disclosed and the resulting implementations will perform at least substantially the same function(s), in at least substantially the same way(s), to achieve at least substantially the same result(s) as the implementations disclosed. Accordingly, these and other implementations are contemplated by this application and are within the scope of the following claims.

1. A method, comprising:
selecting a component of video information for a picture;
determining a motion vector for the selected video information or for depth information for the picture;
coding the selected video information based on the determined motion vector;
coding the depth information based on the determined motion vector;
generating an indicator that the selected video information and the depth information are coded based on the determined motion vector; and
generating one or more data structures that collectively include the coded video information, the coded depth information, and the generated indicator.

2. The method of claim 1, wherein:
coding the selected video information based on the determined motion vector comprises determining a residue between the selected video information and video information in a reference video picture, the video information in the reference video picture being pointed to by the determined motion vector, and
coding the depth information based on the determined motion vector comprises determining a residue between the depth information and depth information in a reference depth picture, the depth information in the reference depth picture being pointed to by the determined motion vector.

3. The method of claim 1, wherein:
determining the motion vector comprises determining the motion vector for the selected video information,
coding the selected video information based on the determined motion vector comprises determining a residue between the selected video information and video information in a reference video picture, the video information in the reference video picture being pointed to by the determined motion vector, and
coding the depth information based on the determined motion vector comprises:
refining the determined motion vector to produce a refined motion vector; and
determining a residue between the depth information and depth information in a reference depth picture, the depth information in the reference depth picture being pointed to by the refined motion vector.

4. The method of claim 3, further comprising:
generating a refinement indicator that indicates a difference between the determined motion vector and the refined motion vector; and
including the refinement indicator in the generated data structure.

5. The method of claim 1, wherein the picture is a macroblock of a frame.

6. The method of claim 1, further comprising generating an indication that a particular slice of the picture belongs to the selected video information or the depth information, and wherein the data structure further includes the generated indication for the particular slice.

7. The method of claim 6, wherein the indication is provided using at least one high level syntax element.

8. The method of claim 1, wherein the picture corresponds to multi-view video content, and the data structure is generated by interleaving the depth information and the selected video information of a given view of the picture such that the depth information of the given view of the picture follows the selected video information of the given view of the picture.

9. The method of claim 1, wherein the picture corresponds to multi-view video content, and the data structure is generated by interleaving the depth information and the selected video information of a given view of the picture at a given time instance, such that the interleaved depth information and selected video information of the given view of the picture at the given time instance precedes interleaved depth information and selected video information of another view of the picture at the given time instance.

10. The method of claim 1, wherein the picture corresponds to multi-view video content, and the data structure is generated by interleaving the depth information and the selected video information such that the depth information and the selected video information are interleaved by view for each time instance.

11. The method of claim 1, wherein the picture corresponds to multi-view video content, and the data structure is generated by interleaving the depth information and the selected video information such that depth information for multiple views and selected video information for multiple views are interleaved for each time instance.

12. The method of claim 1, wherein the data structure is generated by arranging the depth information as an additional component of the selected video information, the selected video information further including at least one luma component and at least one chroma component.

13. The method of claim 1, wherein a same sampling is used for the depth information and the selected component of video information.

14. The method of claim 13, wherein the selected component of video information is a luminance component or a chrominance component.

15. The method of claim 1, wherein the method is performed by an encoder.

16. An apparatus, comprising:
means for selecting a component of video information for a picture;
means for determining a motion vector for the selected video information or for depth information for the picture;
means for coding the selected video information based on the determined motion vector;
means for coding the depth information based on the determined motion vector;
generating an indicator that the selected video information and the depth information are coded based on the determined motion vector; and
means for generating one or more data structures that collectively include the coded video information, the coded depth information, and the generated indicator.

17. A processor readable medium having stored thereon instructions for causing a processor to perform at least the following:
selecting a component of video information for a picture;
determining a motion vector for the selected video information or for depth information for the picture;
coding the selected video information based on the determined motion vector;
coding the depth information based on the determined motion vector;
generating an indicator that the selected video information and the depth information are coded based on the determined motion vector; and
generating one or more data structures that collectively include the coded video information, the coded depth information, and the generated indicator.

18. An apparatus, comprising a processor configured to perform at the least the following:
selecting a component of video information for a picture;
determining a motion vector for the selected video information or for depth information for the picture;
coding the selected video information based on the determined motion vector;
coding the depth information based on the determined motion vector;
generating an indicator that the selected video information and the depth information are coded based on the determined motion vector; and
generating one or more data structures that collectively include the coded video information, the coded depth information, and the generated indicator.

19. An apparatus, comprising:
a selector for selecting a component of video information for a picture;
a motion vector generator for determining a motion vector for the selected video information or for depth information for the picture;
a coder for coding the selected video information based on the determined motion vector, and for coding the depth information based on the determined motion vector; and
a generator for generating an indicator that the selected video information and the depth information are coded based on the determined motion vector, and for generating one or more data structures that collectively include the coded video information, the coded depth information, and the generated indicator.

20. The apparatus of claim 19, wherein the apparatus comprises an encoder that includes the selector, the motion vector generator, the coder, the indicator generator, and the stream generator.

21. A signal formatted to include a data structure including coded video information for a picture, coded depth information for the picture, and an indicator that the coded video information and the coded depth information are coded based on a motion vector determined for the video information or for the depth information.

22. A processor-readable medium having stored thereon a data structure including coded video information for a picture, coded depth information for the picture, and an indicator that the coded video information and the coded depth information are coded based on a motion vector determined for the video information or for the depth information.

23. A method comprising:
receiving data that includes coded video information for a video component of a picture, coded depth information for the picture, and an indicator that the coded video information and the coded depth information are coded based on a motion vector determined for the video information or for the depth information;
generating the motion vector for use in decoding both the coded video information and the coded depth information;
decoding the coded video information based on the generated motion vector, to produce decoded video information for the picture; and
decoding the coded depth information based on the generated motion vector, to produce decoded depth information for the picture.

24. The method of claim 23, further comprising:
generating a data structure that includes the decoded video information and the decoded depth information;
storing the data structure for use in at least one decoding; and
displaying at least a portion of the picture.

25. The method of claim 23, further comprising receiving an indication, in the received data structure, that a particular slice of the picture belongs to the coded video information or the coded depth information.

26. The method of claim 25, wherein the indication is provided using at least one high level syntax element.

27. The method of claim 23, wherein the received data is received with the coded depth information arranged as an additional video component of the picture.

28. The method of claim 23, wherein the method is performed by a decoder.

29. A method comprising:
means for receiving data that includes coded video information for a video component of a picture, coded depth information for the picture, and an indicator that the coded video information and the coded depth information are coded based on a motion vector determined for the video information or for the depth information;
means for generating the motion vector for use in decoding both the coded video information and the coded depth information;
means for decoding the coded video information based on the generated motion vector, to produce decoded video information for the picture; and
means for decoding the coded depth information based on the generated motion vector, to produce decoded depth information for the picture.

30. A processor readable medium having stored thereon instructions for causing a processor to perform at least the following:
receiving data that includes coded video information for a video component of a picture, coded depth information for the picture, and an indicator that the coded video information and the coded depth information are coded based on a motion vector determined for the video information or for the depth information;
generating the motion vector for use in decoding both the coded video information and the coded depth information;
decoding the coded video information based on the generated motion vector, to produce decoded video information for the picture; and
decoding the coded depth information based on the generated motion vector, to produce decoded depth information for the picture.

31. An apparatus, comprising a processor configured to perform at the least the following:
receiving a data structure that includes coded video information for a video component of a picture, coded depth information for the picture, and an indicator that the coded video information and the coded depth information are coded based on a motion vector determined for the video information or for the depth information;
generating the motion vector for use in decoding both the coded video information and the coded depth information;
decoding the coded video information based on the generated motion vector, to produce decoded video information for the picture; and
decoding the coded depth information based on the generated motion vector, to produce decoded depth information for the picture.

32. An apparatus comprising:
a buffer for receiving data that includes coded video information for a video component of a picture, coded depth information for the picture, and an indicator that the coded video information and the coded depth information are coded based on a motion vector determined for the video information or for the depth information;
a motion vector generator for generating the motion vector for use in decoding both the coded video information and the coded depth information; and
a decoder for decoding the coded video information based on the generated motion vector to produce decoded video information for the picture, and for decoding the coded depth information based on the generated motion vector to produce decoded depth information for the picture.

33. The apparatus of claim 32, further comprising an assembler for generating a data structure that includes the decoded video information and the decoded depth information.

34. The apparatus of claim 32, wherein the apparatus comprises a decoder that includes the buffer, the motion vector generator, and the decoder.

35. An apparatus comprising:
a demodulator configured to receive and demodulate a signal, the signal including coded video information for a video component of a picture, coded depth information for the picture, and an indicator that the coded video information and the coded depth information are coded based on a motion vector determined for the video information or for the depth information; and
a decoder configured to perform at least the following:
generating the motion vector for use in decoding both the coded video information and the coded depth information,
decoding the coded video information based on the generated motion vector, to produce decoded video information for the picture, and
decoding the coded depth information based on the generated motion vector, to produce decoded depth information for the picture.

36. An apparatus comprising:
an encoder configured to perform the following:
selecting a component of video information for a picture, determining a motion vector for the selected video information or for depth information for the picture,
coding the selected video information based on the determined motion vector,
coding the depth information based on the determined motion vector,
generating an indicator that the selected video information and the depth information are coded based on the determined motion vector, and
generating one or more data structures that collectively include the coded video information, the coded depth information, and the generated indicator; and
a modulator configured to modulate and transmit the data structure.
